(19) United States
(12) Patent Application Publication
(10) Pub. No.: US 2026/0367254 A1
(43) Pub. Date: Nov. 19, 2026

(54) APPARATUS AND METHOD FOR PROCESSING SENSOR SIGNAL

(71) Applicant: HL Klemove Corp., Incheon (KR)

(72) Inventor: Eunjong PYO, Incheon (KR)

(73) Assignee: HL Klemove Corp., Incheon (KR)

(21) Appl. No.: 19/552,147

(22) Filed: Feb. 27, 2026

(30) Foreign Application Priority Data
May 13, 2025 (KR) 10-2025-0061925

(51) Int. Cl. G01S 17/931; G01S 13/86; G01S 13/89; G01S 13/931; G01S 17/89; G06T 3/4023; G06T 5/60; G06T 5/77

(52) U.S. Cl. CPC G01S 17/931; G01S 13/865; G01S 13/89; G01S 13/931; G01S 17/89; G06T 3/4023; G06T 5/60; G06T 5/77; G06T 2207/10028; G06T 2207/20081; G06T 2207/30252

(57) ABSTRACT

The present disclosure relates to a sensor signal processing apparatus and method for enhancing resolution of a radar sensor signal based on deep learning. According to the present disclosure, the sensor signal processing apparatus receives a first sensor signal and a second sensor signal, trains a deep learning model by using the first sensor signal as an input and the second sensor signal as a target, and infers, by the trained deep learning model, a sensor signal corresponding to the second sensor signal from the first sensor signal. Accordingly, a low-resolution radar sensor signal may be inferred to a level corresponding to a high-resolution LiDAR sensor signal.

### CROSS-REFERENCE TO RELATED APPLICATION

This application claims priority to and the benefit of Korean Patent Application No. 10-2025-0061925, filed on May 13, 2025, the disclosure of which is incorporated herein by reference in its entirety.

### BACKGROUND

### 1. Technical Field

The present disclosure relates to sensor signal processing technology, and more particularly, to artificial intelligence technology for compensating a signal of a low-resolution sensor by using sensor signals of different types.

### 2. Related Art

As devices and systems that assist a driver's driving, such as autonomous driving systems and advanced driver assistance systems (ADAS), continue to develop, the importance of sensors such as cameras, radar, and LiDAR for such systems has also been increasing.

By using sensors to collect information about a vehicle's surroundings and utilizing the collected information to enable a vehicle to travel without a driver or to assist a driver in avoiding hazardous situations, not only the types of sensors used but also the number of sensors inevitably increase.

Such sensors have different advantages and disadvantages depending on the sensor type, and thus there is a limitation in that sensing required for autonomous driving cannot be fully covered by only a single sensor. Accordingly, vehicle manufacturers have been making efforts to identify sensor combinations capable of mutually compensating for the disadvantages of individual sensors.

A radar sensor is a high-performance sensor capable of four-dimensional sensing, including range, azimuth, elevation, and Doppler velocity. However, compared to a LiDAR sensor that densely senses space, a radar sensor may be regarded as providing a low-quality image having a large amount of noise and many sensing gaps.

The inventors of the present disclosure have conducted research efforts to overcome such limitations of sensing data obtained by conventional radar sensors. As a result of extensive efforts to provide a signal processing apparatus and method capable of improving performance of a radar sensor by training a deep learning model based on a correlation between a radar sensor and a LiDAR sensor, the present disclosure has been completed.

### SUMMARY

An object of the present disclosure is to provide a signal processing apparatus and a method thereof capable of improving sensing performance of a sensor by mutually compensating sensing data detected by different types of sensors.

Meanwhile, other objects of the present invention not explicitly described will be additionally considered within a range that can be readily inferred from the following detailed description and the effects thereof.

A sensor signal processing apparatus according to an embodiment of the present disclosure for solving the above-described technical problem may include a memory including at least one instruction; and a processor configured to execute the at least one instruction stored in the memory, and the processor may be configured to receive a first sensor signal; receive a second sensor signal; train a deep learning model by using the first sensor signal as an input and the second sensor signal as a target; and infer, by the trained deep learning model, a sensor signal corresponding to the second sensor signal from the first sensor signal.

In an embodiment of the present disclosure, the first sensor signal may be a low-resolution sensor signal, and the second sensor signal may be a high-resolution sensor signal.

In an embodiment of the present disclosure, the first sensor signal may be a radar sensor signal, and the second sensor signal may be a LiDAR sensor signal.

In an embodiment of the present disclosure, the deep learning model may be trained by comparing an image based on the first sensor signal with an image based on the second sensor signal, such that a region present only in the image based on the second sensor signal is inferred from the first sensor signal.

In an embodiment of the present disclosure, the deep learning model may be trained to reconstruct a masked image by assuming, as the masked image, an image region based on the first sensor signal corresponding to a region present only in the image based on the second sensor signal.

In an embodiment of the present disclosure, the deep learning model may be trained by using a Masked Image Modeling (MIM) method.

In an embodiment of the present disclosure, the deep learning model may be a Masked Autoencoder (MAE) model.

In an embodiment of the present disclosure, a loss function of the deep learning model may be Mean Squared Error (MSE).

In an embodiment of the present disclosure, the deep learning model may be further trained by fine-tuning after completion of training, according to a task purpose for which the deep learning model is used.

A sensor signal processing method according to an embodiment of the present disclosure for solving the above-described technical problem may include receiving a first sensor signal; receiving a second sensor signal; training a deep learning model by using the first sensor signal as an input and the second sensor signal as a target; and inferring, by the trained deep learning model, a sensor signal corresponding to the second sensor signal from the first sensor signal.

In an embodiment of the present disclosure, the first sensor signal may be a low-resolution sensor signal, and the second sensor signal may be a high-resolution sensor signal.

In an embodiment of the present disclosure, the first sensor signal may be a radar sensor signal, and the second sensor signal may be a LiDAR sensor signal.

In an embodiment of the present disclosure, the deep learning model may be trained by comparing an image based on the first sensor signal with an image based on the second sensor signal, such that a region present only in the image based on the second sensor signal is inferred from the first sensor signal.

In an embodiment of the present disclosure, the deep learning model may be trained to reconstruct a masked image by assuming, as the masked image, an image region based on the first sensor signal corresponding to a region present only in the image based on the second sensor signal.

In an embodiment of the present disclosure, the deep learning model may be trained by using a Masked Image Modeling (MIM) method.

In an embodiment of the present disclosure, the deep learning model may be a Masked Autoencoder (MAE) model.

In an embodiment of the present disclosure, a loss function of the deep learning model may be Mean Squared Error (MSE).

In an embodiment of the present disclosure, after the step of training the deep learning model, the deep learning model may be further trained by fine-tuning according to a task purpose for which the deep learning model is used.

In addition, a sensor signal processing apparatus according to an embodiment of the present disclosure for solving the above-described technical problem may include a first sensor; a memory storing at least one instruction and a deep learning model; and a processor configured to execute the at least one instruction stored in the memory, and the processor may be configured to receive a first sensor signal from the first sensor, input the first sensor signal to the deep learning model to infer a sensor signal at a level of a second sensor signal, the second sensor providing a higher resolution than the first sensor, and control a vehicle based on the sensor signal at the level of the second sensor signal, or provide information corresponding to the sensor signal at the level of the second sensor signal to a vehicle control apparatus.

In an embodiment of the present disclosure, the deep learning model may be trained in advance based on a data set including a plurality of first sensing data of the first sensor and a plurality of second sensing data of the second sensor.

According to the present disclosure, disadvantages of different types of sensors can be mutually compensated for through signal processing.

In addition, by compensating for low resolution of a radar sensor, prediction results comparable to those of a LiDAR sensor can be obtained.

Meanwhile, even effects not explicitly mentioned herein are to be regarded as being described in the present specification, insofar as such effects and potential effects are expected from the technical features of the present invention as set forth in the following description.

### BRIEF DESCRIPTION OF THE DRAWINGS

FIG. 1 is a schematic structural diagram of a sensor signal processing apparatus according to an exemplary embodiment of the present disclosure.

FIG. 2 is a more detailed structural diagram of a processor of the sensor signal processing apparatus according to an exemplary embodiment of the present disclosure.

FIG. 3 illustrates an example of an application according to a downstream task of a deep learning model of the sensor signal processing apparatus according to an exemplary embodiment of the present disclosure.

FIG. 4 illustrates an example of image prediction performed by a deep learning model of the sensor signal processing apparatus according to an exemplary embodiment of the present disclosure.

FIG. 5 is a schematic flowchart of a sensor signal processing method according to another exemplary embodiment of the present disclosure.

FIG. 6 is a diagram for explaining a computing environment including a computing apparatus according to another exemplary embodiment of the present disclosure.

FIG. 7 illustrates an example of multi-view representations according to different types of sensors.

The accompanying drawings are provided for reference to facilitate understanding of the technical spirit of the present disclosure, and the scope of the present disclosure is not limited by the drawings.

### DETAILED DESCRIPTION OF EMBODIMENT

Hereinafter, specific embodiments according to exemplary embodiments of the present disclosure will be described with reference to the accompanying drawings. The following detailed description is provided to aid in a comprehensive understanding of the methods, apparatuses, and/or systems described herein. However, these are merely examples, and the present disclosure is not limited thereto.

In describing the exemplary embodiments of the present disclosure, detailed descriptions of well-known technologies related to the present disclosure will be omitted when it is determined that such descriptions may unnecessarily obscure the essence of the embodiments. The terms described below are defined in consideration of the functions of the present disclosure and may vary depending on the intention or custom of the user or operator, or other practices. Therefore, the definitions of the terms should be interpreted based on the overall contents of this specification. The terminology used in the detailed description is merely intended to describe exemplary embodiments and should not be interpreted as limiting. Unless clearly stated otherwise, expressions in the singular form include the plural form as well. In this description, expressions such as “comprise,” “include,” or “provide” are intended to indicate the presence or possibility of one or more characteristics, numbers, steps, operations, or elements, or combinations thereof, and should not be construed as excluding the presence or possibility of one or more other characteristics, numbers, steps, operations, or elements, or combinations thereof. In addition, terms such as “unit,” “device,” “module,” and “block,” as used in the present specification, refer to functional elements configured to perform at least one function or operation and may be implemented in hardware, in software, or in a combination of hardware and software.

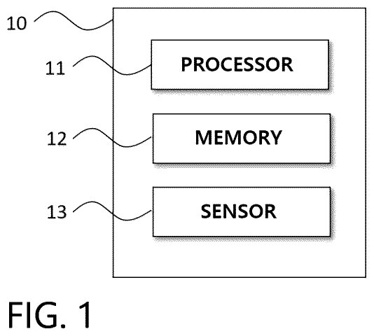

FIG. 1 is a schematic structural diagram of a sensor signal processing apparatus according to an exemplary embodiment of the present disclosure.

The sensor signal processing apparatus 10 according to the present disclosure may include at least one processor 11 and a memory 12.

The memory 12 may store instructions, data structures, and program code that can be read by the processor 11. In embodiments, at least the operations performed by the processor 11 may be implemented by executing the instructions or code of a program stored in the memory 12.

The memory 12 may include a flash memory type, a hard disk type, a multimedia card micro type, or a card-type memory (e.g., SD or XD memory), and may include non-volatile memory such as ROM (Read-Only Memory), EEPROM (Electrically Erasable Programmable Read-Only Memory), PROM (Programmable Read-Only Memory), magnetic memory, magnetic disks, or optical disks, and volatile memory such as RAM (Random Access Memory) or SRAM (Static Random Access Memory).

The memory 12 may store at least one instruction or program that may be used by the sensor signal processing apparatus 10 to enhance a resolution of an image generated by a LiDAR sensor or a radar sensor depending on circumstances.

The processor 11 controls overall operations of the sensor signal processing apparatus 10. For example, the processor 11 may control overall operations of the sensor signal processing apparatus 10 for enhancing or compensating a resolution of a sensor signal by executing the at least one instruction stored in the memory 12.

The processor 11 may include, for example, at least one of a central processing unit (CPU), a microprocessor, a graphics processing unit (GPU), an application-specific integrated circuit (ASIC), a digital signal processor (DSP), a digital signal processing device (DSPD), a programmable logic device (PLD), a field programmable gate array (FPGA), an application processor, a neural processing unit (NPU), or a processor dedicated to artificial intelligence designed with a hardware architecture specialized for processing AI models, but is not limited thereto.

A sensor 13 is used to acquire environmental information in front of or around a vehicle.

For this purpose, the sensor 13 may include a LiDAR sensor, a radar sensor, a camera sensor, or the like, but is not limited thereto.

The LiDAR sensor emits millions of laser pulses per second and analyzes the reflected light to generate an image.

Since the LiDAR sensor uses laser light with strong straight-line propagation characteristics and a short wavelength, it provides higher precision compared to sensors such as radars that use radio waves.

Unlike the LiDAR sensor that uses light (laser), the radar sensor detects the distance, direction, and speed of an object using electromagnetic waves.

Although the radar sensor is less precise than the LiDAR sensor, it has the advantage of being less affected by environmental factors such as snow, rain, fog, and dust.

The camera sensor is used to acquire environmental information around the vehicle based on light reflected from objects.

A LiDAR sensor and a radar sensor may both be used to generate multi-view representations for autonomous driving of a vehicle and the like.

However, due to characteristics of each sensor, multi-view representations generated by the two sensors exhibit different characteristics.

FIG. 7 illustrates an example of multi-view representations according to different types of sensors.

In the case of a bird's-eye view (BEV) and a range view generated by a LiDAR sensor, sensing results obtained by the sensor are very dense, and thus surrounding situations can be accurately perceived.

In contrast, a bird's-eye view and a range view generated by a radar sensor have a significantly lower density than the multi-view representations generated by the LiDAR sensor, and therefore it can be confirmed that they are insufficient for comprehensively understanding an overall situation.

Accordingly, the present disclosure aims to elevate multi-view representations generated by a radar sensor to a level of multi-view representations generated by a LiDAR sensor by using a deep learning model.

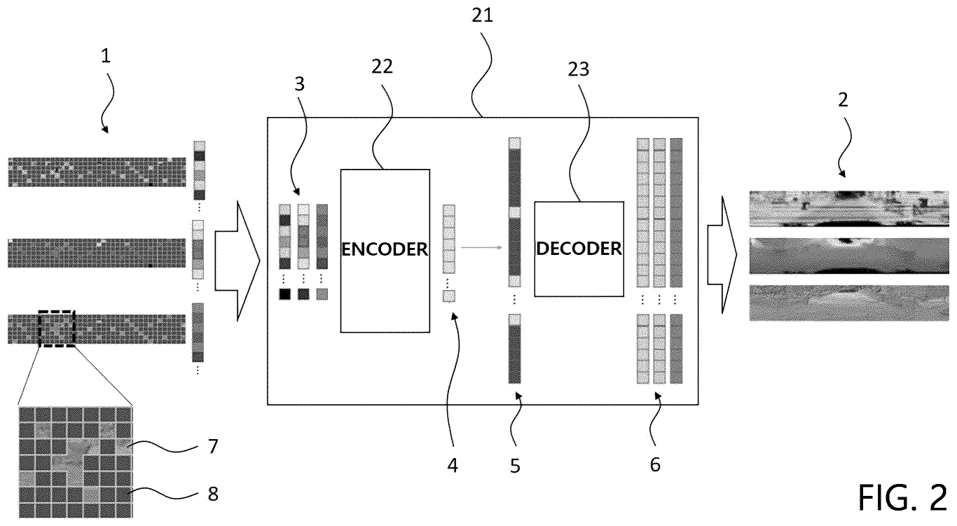

FIG. 2 is a more detailed structural diagram of a processor of the sensor signal processing apparatus according to an exemplary embodiment of the present disclosure.

The processor 11 may include at least one deep learning model 21 for sensor signal processing, and the deep learning model 21 may be trained to receive a first sensor signal 1 as an input and to generate a signal at a level similar to that of a second sensor signal 2.

The first sensor signal 1 and the second sensor signal 2 may be stored in advance in the memory 12 as a plurality of data sets, or may be received by the processor 11 from an external terminal (not shown).

The first sensor signal 1 and the second sensor signal 2 may be sensing data obtained by different sensors for the same scene, including a target and a background.

The deep learning model 21 may be trained by using the first sensor signal 1 as an input and the second sensor signal 2 as a target signal.

The first sensor signal 1 and the second sensor signal 2 may be signals received from different sensors 13, respectively.

For example, the first sensor signal 1 may be a low-resolution signal, and the second sensor signal 2 may be a high-resolution signal.

Hereinafter, the first sensor signal 1 will be described as being a radar sensor signal and the second sensor signal 2 will be described as being a LiDAR sensor signal; however, the sensor signals are not limited thereto, and the present disclosure may be applied to various types of sensor signals, including radar sensor signals, LiDAR sensor signals, and camera sensor signals.

The first sensor signal 1, which is a radar sensor signal, may have a lower resolution than the second sensor signal 2, which is a LiDAR sensor signal.

That is, the first sensor signal 1 may be a multi-view sensing signal, and when the first sensor signal 1 is generated as a two-dimensional image, the image may be divided into a region 7 in which a signal is sensed and a region 8 in which no signal is sensed.

The deep learning model 21 according to the present disclosure may be trained to infer the region 8 in which no signal is sensed by using only the region 7 in which a signal is sensed among images generated by the first sensor signal 1, and to remove noise from the region 7 in which a signal is sensed.

For this purpose, the deep learning model 21 may be trained using a Masked Image Modeling (MIM) method; however, the training method is not limited thereto.

The deep learning model 21 may reconstruct the first sensor signal 1 into an image corresponding to the second sensor signal 2.

That is, an omnidirectional image projected in the same manner as the second sensor signal 2 may be generated from the first sensor signal 1 composed only of the region 7 in which a signal is sensed.

For this purpose, the deep learning model 21 is trained by treating the region 7 in which a signal is sensed as an unmasked patch and the region 8 in which no signal is sensed as a masked patch, based on an image of the second sensor signal 2 as a target image. Accordingly, the deep learning model 21 may be a Masked Autoencoder (MAE) model trained to infer unmasked patches from masked patches.

Unmasked patches 3 composed only of regions in which a signal is sensed in an image of the first sensor signal 1 are converted into a latent vector 4 by an encoder 22 of the deep learning model 21.

Since the latent vector 4 is a result obtained by converting only the unmasked patches 3, vectors 5 obtained by adding masked patches to the latent vector 4 may be transformed 6 by a decoder 23, and the decoder 23 of the deep learning model 21 may be trained to generate an image of the second sensor signal 2 as a target image.

In training the deep learning model 21, a loss function may be designed in various ways according to an objective of the deep learning model 21.

For example, when the objective of the deep learning model 21 is to enhance a resolution of the first sensor signal 1 and to remove noise, a loss function may be designed to minimize an error with respect to the target image by using Mean Squared Error (MSE).

As the loss function of the deep learning model 21, loss functions for other multi-tasks in addition to Mean Squared Error (MSE) may be added.

In addition, the loss function may be designed separately for unmasked patches 7 and masked patches 8, and may be trained to be used simultaneously for both cases.

After training of the deep learning model 21 is completed such that the second sensor signal 2 can be inferred from the first sensor signal 1, fine-tuning of the deep learning model 21 may be performed according to a specific downstream task.

The downstream task may include object detection, object tracking, semantic segmentation, and panoptic segmentation, but is not limited thereto.

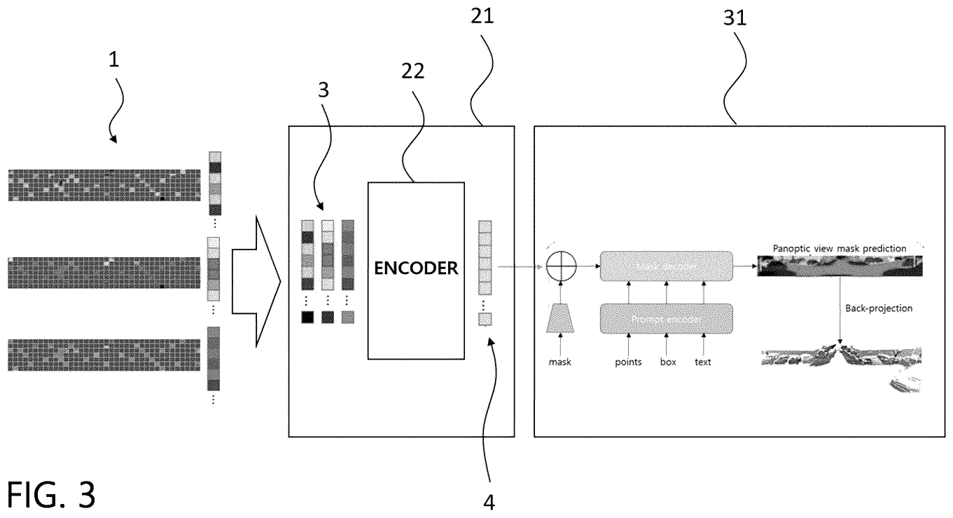

FIG. 3 illustrates an example of an application according to a downstream task of a deep learning model of the sensor signal processing apparatus according to an exemplary embodiment of the present disclosure.

The example of FIG. 3 illustrates an example in which the deep learning model 21 according to the present disclosure is used when the downstream task is panoptic segmentation.

An output 4 of an encoder 22 of the deep learning model 21 according to the present disclosure is input to a panoptic segmentation model 31, masking information is added thereto, and decoding is performed to execute panoptic segmentation.

Panoptic segmentation is a concept in which semantic segmentation and instance segmentation are combined, and is a model that distinguishes both a class and an instance of an object in an image.

Depending on an additional downstream task, parameters of the encoder 22 may be fine-tuned and used.

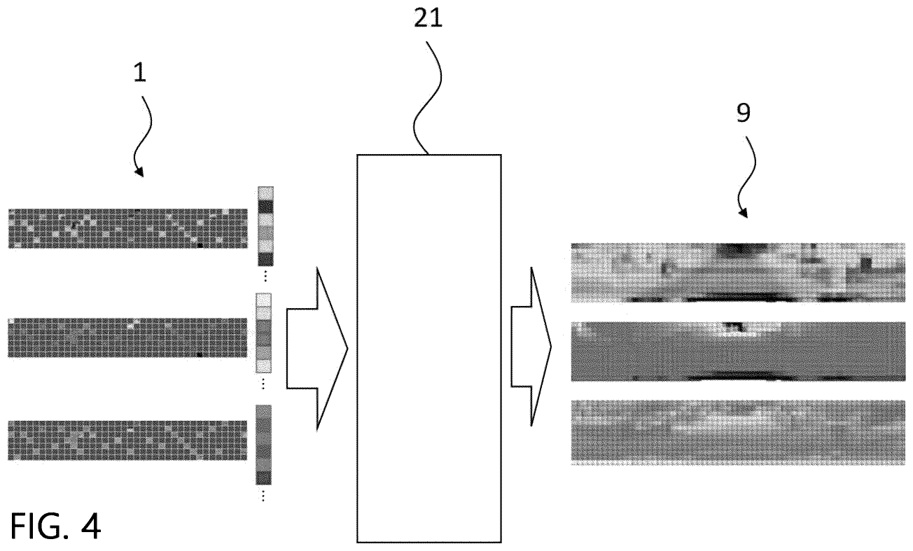

FIG. 4 illustrates an example of image prediction performed by a deep learning model of the sensor signal processing apparatus according to an exemplary embodiment of the present disclosure.

By the deep learning model 21 for which training has been completed, reconstruction of the first sensor signal 1, that is, prediction of portions in which a sensor sensing signal is absent, is performed, thereby generating a sensor image 9 at a level similar to that of the second sensor signal 2.

Accordingly, according to the sensor signal processing apparatus 10 of the present disclosure, a sensor signal at a level of the second sensor signal having a high resolution can be generated from the first sensor signal having a low resolution.

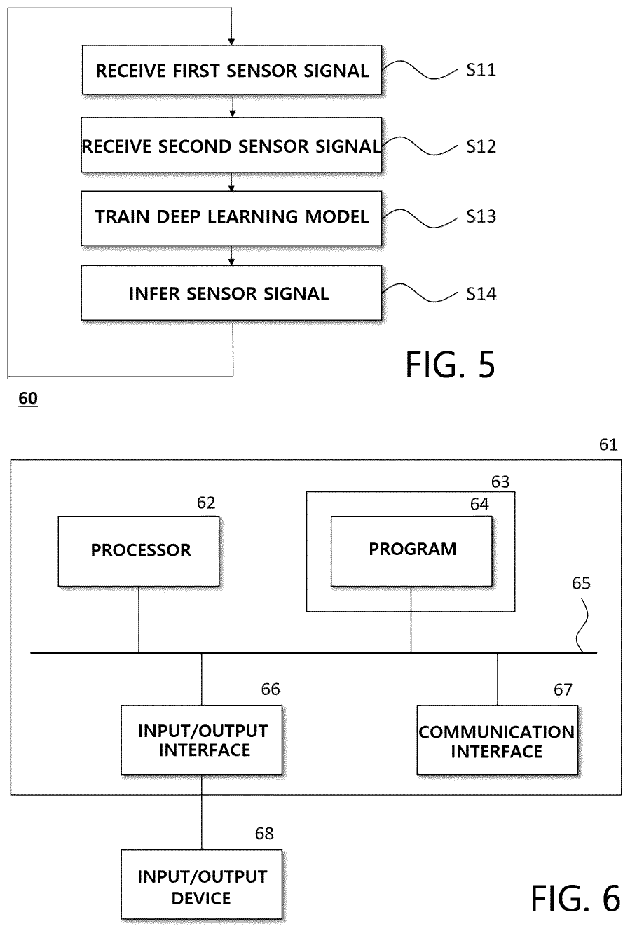

FIG. 5 is a schematic flowchart of a sensor signal processing method according to another exemplary embodiment of the present disclosure.

The sensor signal processing method according to the present disclosure may be performed by a sensor signal processing apparatus including at least one processor and a memory.

For training a deep learning model of the sensor signal processing apparatus, a first sensor signal is received (S11) and a second sensor signal is received (S12).

The first sensor signal may be a low-resolution sensor signal such as a radar sensor signal, and the second sensor signal may be a high-resolution sensor signal such as a LiDAR sensor signal; however, the sensor signals are not limited thereto.

Training of the deep learning model is performed based on the first sensor signal and the second sensor signal (S13).

The deep learning model is trained by using the first sensor signal as an input and the second sensor signal as a target signal.

That is, among the first sensor signal, regions common to the first sensor signal and the second sensor signal are treated as unmasked patches, and regions of the first sensor signal that are not present in the second sensor signal are treated as masked patches, such that the deep learning model may be trained using a Masked Image Modeling (MIM) method to reconstruct masked patches of the first sensor signal.

For this purpose, the first sensor signal may be reconstructed to have the same resolution as the second sensor signal, and reconstruction is performed by filling regions in which the first sensor signal is absent with masked patches.

During the training process, a loss function of the deep learning model may be designed differently depending on an application of the deep learning model. As one example, the loss function may use Mean Squared Error (MSE); however, the loss function is not limited thereto.

As described above, the deep learning model may be a Masked Autoencoder (MAE) model.

After training is completed, the deep learning model may be fine-tuned according to a specific downstream task.

After training of the deep learning model is completed, a sensor signal at a level of the second sensor signal is inferred by the deep learning model by receiving the first sensor signal as an input (S14).

For example, a radar sensor signal having a low resolution may be input to the deep learning model to infer a sensor signal at a level of a high-resolution LiDAR sensor signal.

In addition, the processor 11 may apply the inferred sensor signal at the level of the second sensor signal to vehicle control, or may provide information corresponding to the inferred sensor signal to a vehicle control apparatus.

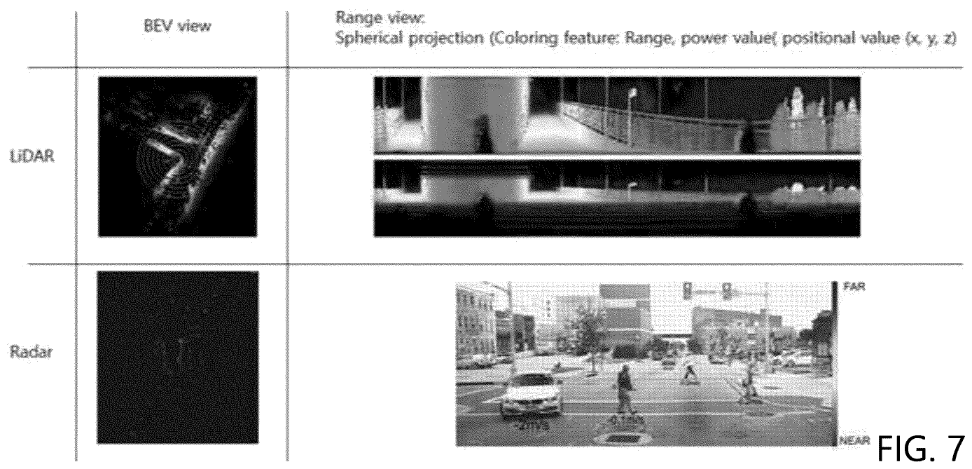

FIG. 6 is a diagram for explaining a computing environment including a computing apparatus according to another exemplary embodiment of the present disclosure.

In the illustrated embodiment, each component may have different functions and capabilities in addition to those described below, and the illustrated computing environment may include additional components other than those described below. The illustrated computing environment 60 includes a computing apparatus 61, which may perform the sensor signal processing method illustrated in FIG. 5. In one embodiment, the computing apparatus 61 may be one or more components included in the sensor signal processing apparatus illustrated in FIG. 1.

The computing apparatus 61 includes at least one processor 62, a computer-readable storage medium 63, and a communication bus 65. The processor 62 may cause the computing apparatus 61 to operate according to the exemplary embodiments described above. For example, the processor 62 may execute at least one program 64 stored in the computer-readable storage medium 63. The at least one program 64 may include one or more computer-executable instructions, and the computer-executable instructions, when executed by the processor 62, may be configured to cause the computing apparatus 61 to perform operations according to the exemplary embodiments.

The communication bus 65 interconnects various other components of the computing apparatus 61, including the processor 62 and the computer-readable storage medium 63.

The computing apparatus 61 may further include at least one input/output (I/O) interface 66 that provides an interface for at least one input/output device 68, and at least one communication interface 67. The input/output interface 66 and the communication interface 67 are connected to the communication bus 65. The input/output device 68 may be connected to other components of the computing apparatus 61 via the input/output interface 66. Exemplary input/output devices 68 may include at least one input device such as a pointing device (e.g., a mouse or a trackpad), a keyboard, a touch input device (e.g., a touchpad or a touchscreen), a voice or audio input device, various types of sensor devices, and/or imaging devices, and/or at least one output device such as a display device, a printer, a speaker, and/or a network card. The exemplary input/output devices 68 may be included inside the computing apparatus 61 as at least one component constituting the computing apparatus 61, or may be connected to the computing apparatus 61 as at least one separate device distinct from the computing apparatus 61.

Accordingly, according to the sensor signal processing apparatus and method of the present disclosure, performance in application fields such as object detection and object inference can be improved by inferring a low-resolution sensor signal, such as a radar sensor signal, to a level of a high-resolution sensor signal, such as a LiDAR sensor signal.

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

What is claimed is:

1. A sensor signal processing apparatus, comprising:
a memory including at least one instruction; and
a processor configured to execute the at least one instruction stored in the memory,
wherein the processor is configured to:
receive a first sensor signal;
receive a second sensor signal;
train a deep learning model by using the first sensor signal as an input and the second sensor signal as a target; and
infer, by the trained deep learning model, a sensor signal corresponding to the second sensor signal from the first sensor signal.

2. The apparatus of claim 1,
wherein the first sensor signal is a low-resolution sensor signal, and
wherein the second sensor signal is a high-resolution sensor signal.

3. The apparatus of claim 1,
wherein the first sensor signal is a radar sensor signal, and
wherein the second sensor signal is a LiDAR sensor signal.

4. The apparatus of claim 1, wherein the deep learning model is trained by comparing an image based on the first sensor signal with an image based on the second sensor signal, such that a region present only in the image based on the second sensor signal is inferred from the first sensor signal.

5. The apparatus of claim 4, wherein the deep learning model is trained to reconstruct a masked image by assuming, as the masked image, an image region based on the first sensor signal corresponding to a region present only in the image based on the second sensor signal.

6. The apparatus of claim 4, wherein the deep learning model is trained by using a Masked Image Modeling (MIM) method.

7. The apparatus of claim 1, wherein the deep learning model is a Masked Autoencoder (MAE) model.

8. The apparatus of claim 1, wherein a loss function of the deep learning model is Mean Squared Error (MSE).

9. The apparatus of claim 1, wherein the deep learning model is further trained by fine-tuning after completion of training, according to a task purpose for which the deep learning model is used.

10. A sensor signal processing method performed by a sensor signal processing apparatus comprising at least one processor and a memory, the method comprising:
receiving a first sensor signal;
receiving a second sensor signal;
training a deep learning model by using the first sensor signal as an input and the second sensor signal as a target; and
inferring, by the trained deep learning model, a sensor signal corresponding to the second sensor signal from the first sensor signal.

11. The method of claim 10,
wherein the first sensor signal is a low-resolution sensor signal, and
wherein the second sensor signal is a high-resolution sensor signal.

12. The method of claim 10,
wherein the first sensor signal is a radar sensor signal, and
wherein the second sensor signal is a LiDAR sensor signal.

13. The method of claim 10, wherein the deep learning model is trained by comparing an image based on the first sensor signal with an image based on the second sensor signal, such that a region present only in the image based on the second sensor signal is inferred from the first sensor signal.

14. The method of claim 13, wherein the deep learning model is trained to reconstruct a masked image by assuming, as the masked image, an image region based on the first sensor signal corresponding to a region present only in the image based on the second sensor signal.

15. The method of claim 13, wherein the deep learning model is trained by using a Masked Image Modeling (MIM) method.

16. The method of claim 10, wherein the deep learning model is a Masked Autoencoder (MAE) model.

17. The method of claim 10, wherein a loss function of the deep learning model is Mean Squared Error (MSE).

18. The method of claim 10, wherein, after the step of training the deep learning model, the deep learning model is further trained by fine-tuning according to a task purpose for which the deep learning model is used.

19. A sensor signal processing apparatus, comprising:
a first sensor;
a memory storing at least one instruction and a deep learning model; and
a processor configured to execute the at least one instruction stored in the memory,
wherein the processor is configured to:
receive a first sensor signal from the first sensor,
input the first sensor signal to the deep learning model to infer a sensor signal at a level of a second sensor signal, the second sensor providing a higher resolution than the first sensor, and
control a vehicle based on the sensor signal at the level of the second sensor signal, or provide information corresponding to the sensor signal at the level of the second sensor signal to a vehicle control apparatus.

20. The apparatus of claim 19, wherein the deep learning model is trained in advance based on a data set including a plurality of first sensing data of the first sensor and a plurality of second sensing data of the second sensor.
